(19) United States
(12) Patent Application Publication
(10) Pub. No.: US 2023/0288588 A1
(43) Pub. Date: Sep. 14, 2023

(54) SYSTEM AND METHOD FOR SEISMIC VELOCITY AND ANISOTROPIC PARAMETER MODELING

(71) Applicant: Chevron U.S.A. Inc., San Ramon, CA (US)

(72) Inventors: Andrey Hanan Shabelansky, Bellaire, TX (US); Huafeng Liu, Bellaire, TX (US); Cory James Hoelting, West University Place, TX (US); Min Yang, Houston, TX (US); Jinsong Chen, Fulshear, TX (US)

(21) Appl. No.: 17/654,632

(22) Filed: Mar. 14, 2022

(51) Int. Cl. G01V 1/28; G06F 30/20

(52) U.S. Cl. CPC G01V 1/282; G06F 30/20; G06F 2111/08

(57) ABSTRACT

A method is described for stochastic modeling of seismic velocity and anisotropic parameters, including receiving 3D bounds of normal moveout velocity (Vₙₘₒ) and anisotropic parameter η; modeling 3D bounds for vertical velocity V and anisotropic parameter δ based on the 3D bounds of Vₙₘₒ and η; generating 3D model realizations of V, η, and δ within the 3D bounds; and testing detectability of each of the 3D model realizations to create a detectable subset of model realizations wherein the detectability identifies which 3D model realizations will produce images with flat migrated gathers. The method may be executed by a computer system.

### TECHNICAL FIELD

The disclosed embodiments relate generally to techniques for stochastic modeling of seismic velocity and anisotropic parameters.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. Seismic acquisition over subsurface structure generally produces time-domain data, which is then migrated to, for example, depth image data. The migration process necessarily involves certain assumptions regarding the propagation velocity of elastic waves through the subsurface materials and structures. Moreover, there is generally some degree of anisotropy in geological formations. That is, while it may be possible to determine vertical velocities using well data, the velocities estimated using multi-offset seismic techniques will necessarily be somewhat different from measured vertical velocities. Finally, because assumptions, based on measurement or estimation, regarding both velocities and degrees of anisotropy may be incorrect, there is some inherent uncertainty in the resulting depth image, both in the depth of imaged events and in the structural interpretation of the events.

Models of the subsurface obtained from geophysical measurements are inherently non-unique. Geophysical measurements are finite in resolution and relate to many orders of magnitude of scale. Uncertainty in the measurements results from a variety of sources, including signal-to-noise ratio, data acquisition parameter selection, processing algorithms, or the above-mentioned velocity and anisotropy parameter selection. It is therefore important to understand the degree of that uncertainty when evaluating model results. That is, it is important to quantitatively understand to what degree the models are sensitive to a given change or group of changes in the assumptions regarding velocities, anisotropy or the other factors impacting uncertainty. Existing state-of-the-art methods only generate models and corresponding depth uncertainty locally and do not provide a sufficient number of 3D plausible models that satisfy the locally 1D assumption. This limitation is a key barrier to further integrate those models from 1D assumption with other constrained that may be available and, thus, limits the ability to define a more accurate depth uncertainty. An understanding of the uncertainty and the range of possible characterizations allows interpreters of the data to make business decisions regarding reserve estimation, well placement and count, development scenarios, secondary recovery strategies and other factors that ultimately impact recovery and project economics.

### SUMMARY

In accordance with some embodiments, a method of stochastic modeling of seismic velocity and anisotropic parameters, including receiving 3D bounds of normal moveout velocity (Vₙₘₒ) and anisotropic parameter η; modeling 3D bounds for vertical velocity V and anisotropic parameter δ based on the 3D bounds of Vₙₘₒ and η; generating 3D model realizations of V, η, and δ within the 3D bounds; and testing detectability of each of the 3D model realizations to create a detectable subset of model realizations wherein the detectability identifies which 3D model realizations will produce images with flat migrated gathers is disclosed. The method may further include converting the detectable subset of model realizations into depth domain. In an embodiment, modeling the 3D bounds for V and δ is done using random numbers generated from a predefined distribution using an empirical relationship or a random relationship between δ-η bounds. In an embodiment, generating the 3D model realizations using the 3D bounds of V, η, and δ is done by sampling within the 3D bounds using random numbers generated from a predefined distribution, generating constant fluctuations with a random number generator using an empirical relation for δ-η bounds or generating constant fluctuations with a random number generator using a random relation for δ-η bounds.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for stochastic modeling of seismic velocity and anisotropic parameters;

FIG. 2 illustrates an example method for modeling of seismic velocity and anisotropic parameters;

FIG. 3 illustrates example input data vertical velocity V₀, η, δ and calculated V_{NMO} in depth domain on the left and time domain on the right;

FIG. 4 illustrates example input bounds;

FIG. 5 illustrates example realization cross-plots for δ-V₀, η -V₀, δ-η and η-V-NMO at a fixed (X,Y,T) using two approaches for modeling V₀, η, δ bounds: empirical on left against random on the right;

FIG. 6 illustrates realizations of V₀, η, δ generated at a fixed (X,Y) by an embodiment of the present invention;

FIG. 7 illustrates a step of an embodiment for identifying which realizations are within the detectability criteria range and which are outside of that range;

FIG. 8 illustrates examples of the cross-plot realizations inside the detectability range for δ-V₀, η -V₀, δ-η and η-V_{NMO} using two approaches for the bounds: empirical on the left against random on the right;

FIG. 9 illustrates an example of the reference model, high and low bounds and six representative realizations of vertical velocity (V₀) using two approaches for the bounds: empirical on the left against random on the right;

FIG. 10 illustrates an example of the reference model, high and low bounds and six representative realizations of anisotropic η parameter using two approaches for the bounds: empirical on the left against random on the right; and

FIG. 11 illustrates an example of the reference model, high and low bounds and six representative realizations of anisotropic Thompson δ parameter using two approaches for the bounds: empirical on the left against random on the right.

Like reference numerals refer to corresponding parts throughout the drawings.

### DETAILED DESCRIPTION OF EMBODIMENTS

Described below are methods, systems, and computer readable storage media that provide a manner of stochastic modeling of seismic velocity (also called vertical velocity) V₀ and anisotropic parameters (η and δ). The method is a low-wavelength approach for generating many realizations of velocity, η, and δ.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

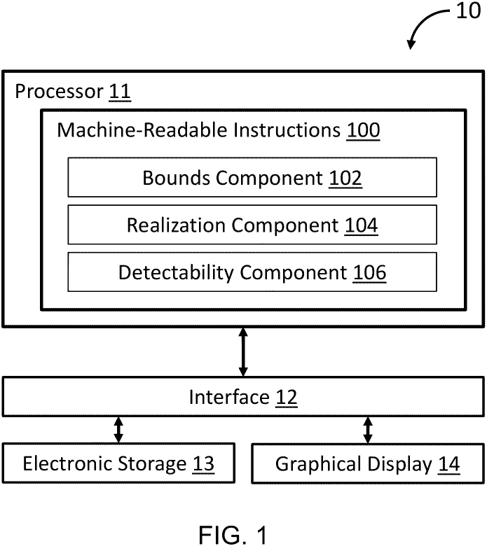

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 12, and/or other components. The processor 11 is configured to execute machine-readable instructions 100 which provide a method of stochastic modeling of seismic velocity and anisotropic parameters (η and δ).

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to velocity, η, δ, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to realizations produced by processor 11, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate of stochastic modeling of seismic velocity and anisotropic parameters (η and δ). The machine-readable instructions 100 may include one or more computer program components. The machine-readable instructions 100 may include a bounds component 102, a realization component 104, a detectability component 106, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the bounds component 102 may be configured to stochastically model 3D bounds for vertical (interval) velocity V₀ and δ. This is done using random numbers generated from a predefined distribution. It may use an empirical relationship or a random relationship between the δ-η bounds.

The realization component 104 may be configured to generate 3D model realizations for each parameter (vertical velocity V₀, η, and δ) by sampling within the 3D bounds using random numbers generated from a predefined distribution (e.g. normal, uniform, and the like). This may be done generating constant fluctuations with a random number generator using empirical relation for δ-η bounds or done by generating constant fluctuations with a random number generator using the random relation for δ-η bounds.

The detectability component 106 may be configured to test the detectability of the realizations that were generated by realization component 104. The realizations are tested against a detectability criterion by running detectability algorithm (i.e., calculate the travel-times using the realization models that are within the 3D bounds) to identify which realizations are inside and outside detectability range. In other words, although all generated models are within the 3D bounds, detectability component 106 seeks to identify which models will produce images with flat migrated gathers and which models will produce images with non-flat gathers. The stochastic modeling performed by bounds component 102 and the realizations generated by realization component 104 will provide a large number of realizations that are within the detectability range (e.g., about one third of the input number of realizations), which is important for further analysis. Conventional methods may have only few percent of the input realizations in the detectability range.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

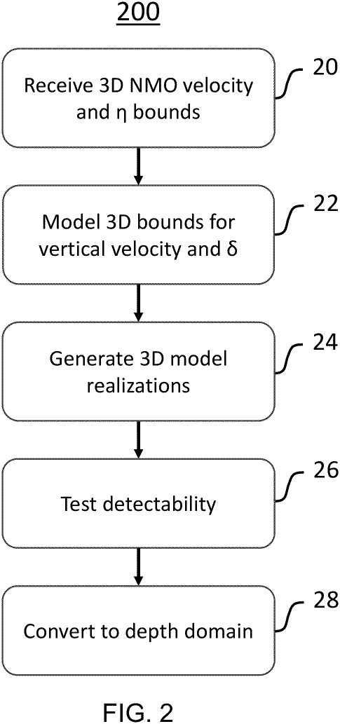

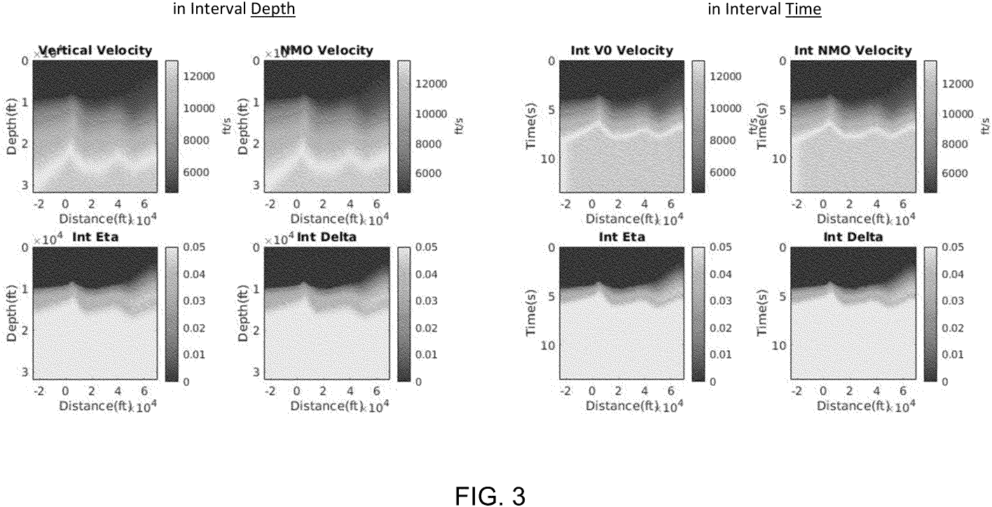

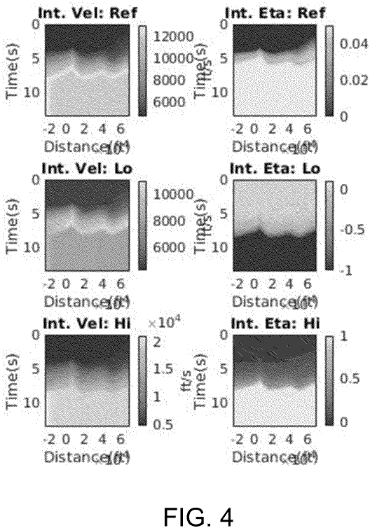

FIG. 2 illustrates an example process 200 for stochastic modeling of seismic velocity and anisotropic parameters (η and δ). At operation 20, 3D normal moveout (NMO) velocity (Vₙₘₒ) and η bounds are received. These inputs may be generated, for example, by a method such as that described in U.S. Pat. 8,694,262. FIG. 3 illustrates examples of input velocity, η, and δ models in depth domain on the left and time domain on the right. FIG. 4 illustrates examples of high and low bounds for Vₙₘₒ and η.

At operation 22, the method stochastically models 3D bounds for vertical velocity V₀ and δ. This is done using random numbers generated from a predefined distribution.The vertical velocity bounds depend on the bounds of Vₙₘₒ and δ (lo and hi). Since the method does not receive the bounds of δ as input, it must stochastically model it and subsequently compute the bound of vertical velocity V₀ via the equations below for an empirical relationship and for a random relationship. Thus, it may use an empirical relationship or a random relationship between the δ-η bounds.

The empirical relationship may be

$${δ}_{\text{lo}} = {δ}_{4 \text{hi}} = \frac{1}{4} {η}_{\text{lo}}$$

$${δ}_{\text{hi}} = {δ}_{4 \text{lo}} = \frac{1}{2} {η}_{\text{hi}}$$

leading to

$${V}_{h i} = \frac{{V}_{n m o , h i}}{\sqrt{1 + 2 {δ}_{4 h i}}} = \frac{{V}_{n m o , h i}}{\sqrt{1 + \frac{1}{2} {η}_{l o}}}$$

$${V}_{l o} = \frac{{V}_{n m o , l o}}{\sqrt{1 + 2 {δ}_{4 l o}}} = \frac{{V}_{n m o , l o}}{\sqrt{1 + {η}_{h i}}}$$

Alternatively, the method may use a random relationship such as

$${δ}_{{\text{lo}}_{\text{j}}} = {δ}_{4 {\text{hi}}_{\text{j}}} = \frac{{α}_{\text{j}}}{4} {η}_{\text{lo}}$$

$${δ}_{{\text{hi}}_{\text{j}}} = {δ}_{4 {\text{lo}}_{\text{j}}} = \frac{{β}_{\text{j}}}{2} {η}_{\text{hi}}$$

where:

$$\frac{{α}_{j}}{4} ∈ U \left[a , b\right] , \frac{{β}_{j}}{2} ∈ U \left[c , d\right]$$

where U[a,b] is a uniform distribution generating values between a and b.This leads to:

$${V}_{h {i}_{j}} \left(t , x\right) = \frac{{V}_{n m o , h i}}{\sqrt{1 + 2 {δ}_{4 h i}}} = \frac{{V}_{n m o , h i} \left(t , x\right)}{\sqrt{1 + \frac{{α}_{j}}{2} {η}_{l o} \left(t , x\right)}}$$

$${V}_{l {o}_{j}} = \frac{{V}_{n m o , l o}}{\sqrt{1 + 2 {δ}_{4 l o}}} = \frac{{V}_{n m o , l o}}{\sqrt{1 + {β}_{j} {η}_{h i}}}$$

These bounds are then used by operation 24 to generate 3D model realizations for each parameter (vertical velocity V₀, η, and δ) by sampling within the 3D bounds using random numbers generated from a predefined distribution (e.g. normal, uniform, and the like). This may be done generating constant fluctuations with a random number generator using empirical relation for δ-η bounds such that for each realization j:

$${R}_{j} \left(t , x\right) = R e f \left(t , x\right) + \left(H i \left(t , x\right) - L o \left(t , x\right)\right) ⋅ {v}_{j}$$

or done generating constant fluctuations with a random number generator using the random relation for δ-η bounds such that for each realization j:

$${R}_{j} \left(t , x\right) = R e f \left(t , x\right) + \left(H {i}_{j} \left(t , x\right) - L {o}_{j} \left(t , x\right)\right) ⋅ {v}_{j}$$

$$w h e r e {v}_{j} ∈ {N}_{\left[- 1 , 1\right]}$$

N_{[a},_{b]} is a distribution (e.g. normal, uniform, ...) generating values between a and b.

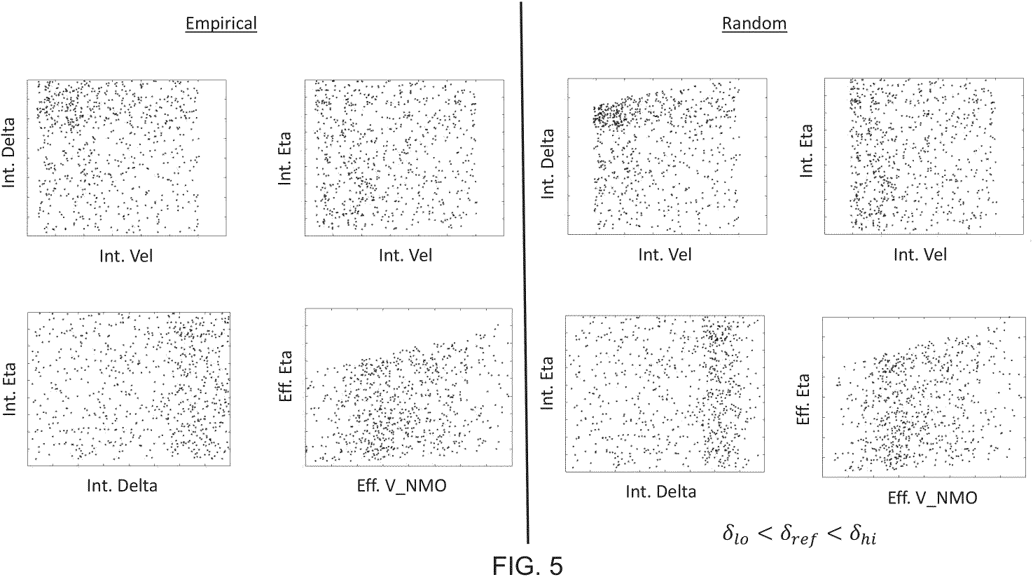

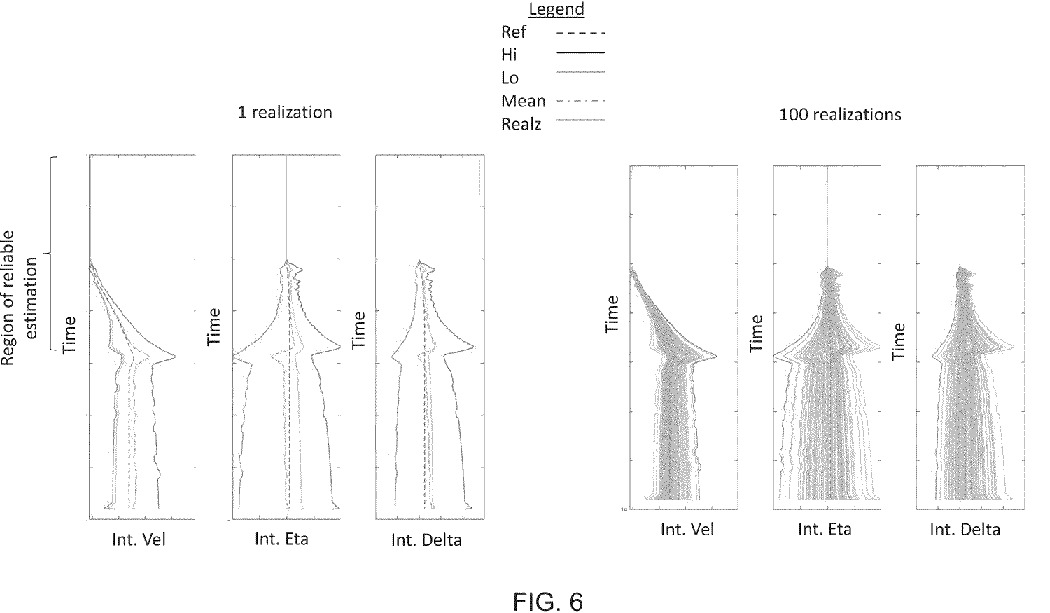

The random relation not only introduces variability between η and δ bounds but also more importantly introduces spatial variability in vertical velocity and δ between each realization. FIG. 5 illustrates example realization cross-plots for δ-V₀, η -V₀, δ-η and η-Vₙₘₒ at a fixed (X,Y,T) using two approaches for modeling V₀, η, δ bounds: empirical on left against random on the right. FIG. 6 illustrates examples of realizations of V, η, and δ that were generated using constant fluctuations with a random number generator. The method can provide hundreds or thousands of realizations.

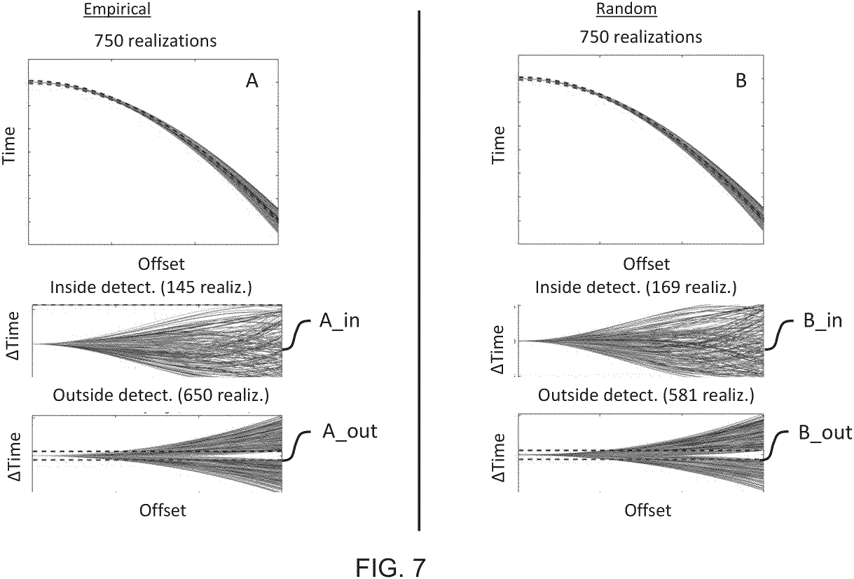

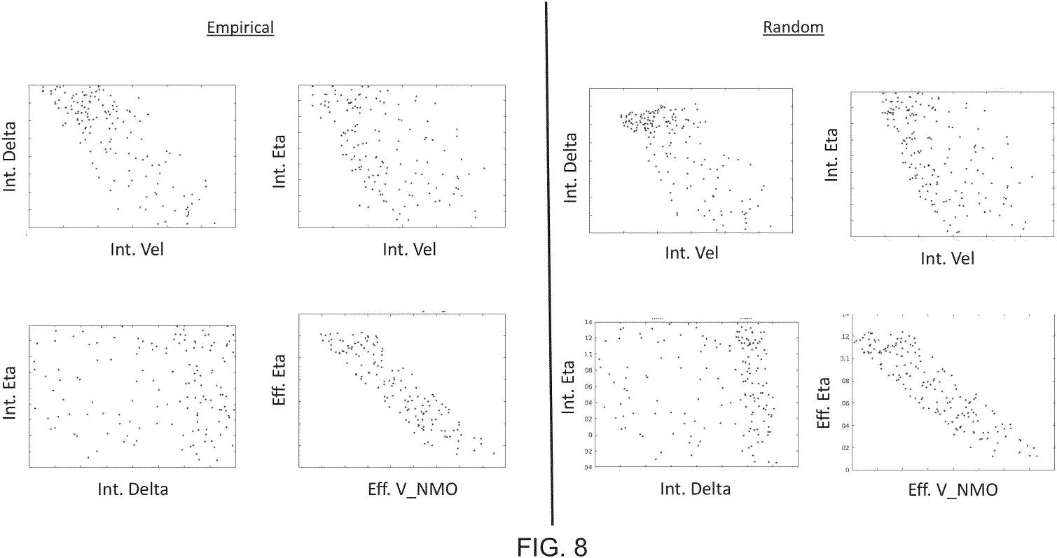

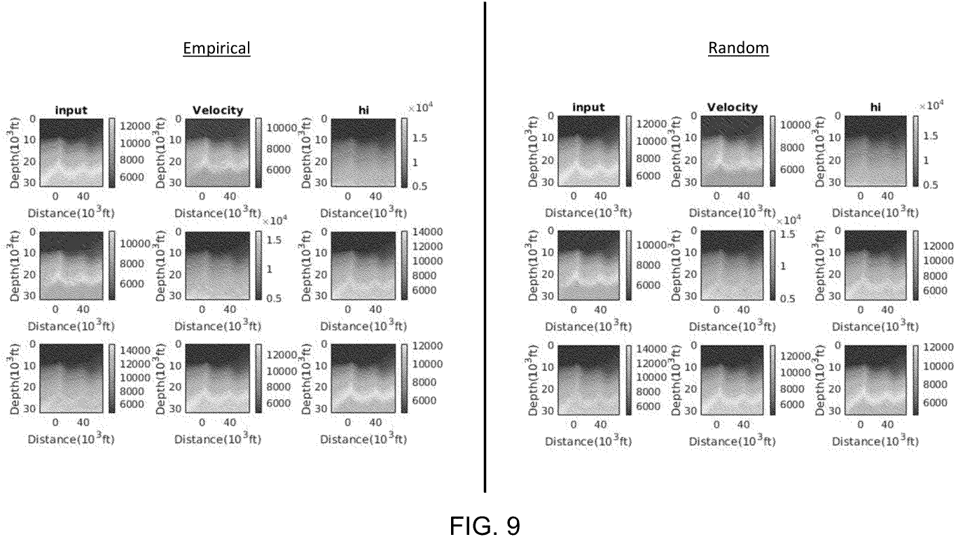

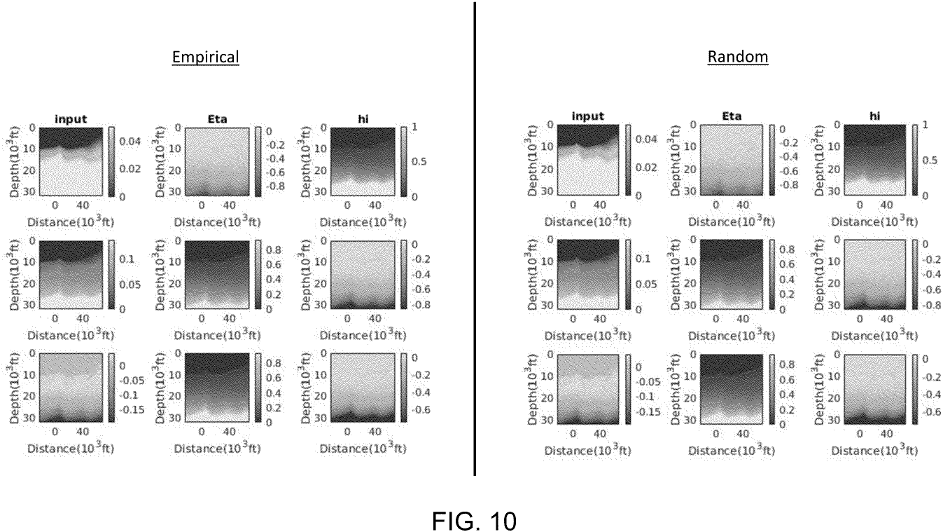

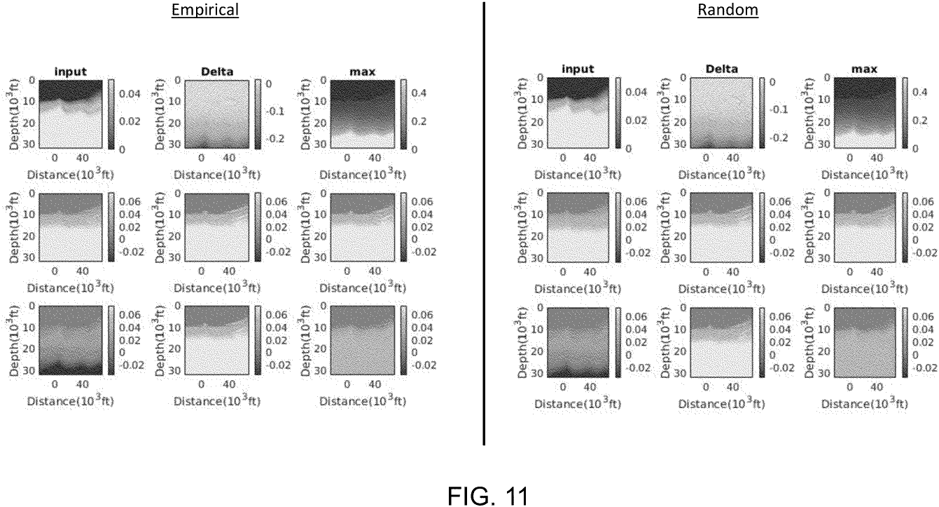

Referring again to FIG. 2, operation 26 tests the detectability of the realizations that were generated at operation 24. The realizations are tested against a detectability criterion by running detectability algorithm (i.e., calculate the travel-times using the realization models that are within the 3D bounds) to identify which realizations are inside and outside detectability range. In other words, although all generated models are models within the 3D bounds, operation 26 seeks to identify which models will produce images with flat migrated gathers and which models will produce images with non-flat gathers. Due to the stochastic modeling of operation 22 followed by the generation of a large number of model realizations by operation 24, there will be a large number of realizations that are inside the detectability range (e.g., about one third of the input number of realizations). Having a large number of realizations within the detectability range is important for further analysis. As an example, FIG. 7 shows 750 realizations of offset gathers (panels A and B) generated by operation 24. The dashed lines indicate the upper and lower bounds of the detectability window. Panels A_in and B_in demonstrate the realizations that lie within the detectability range and panels A_out and B_out demonstrate the realizations that lie outside the detectability range. FIG. 8 shows crossplots of the V, Vₙₘₒ, η, and δ parameters that lie inside the detectability limits. FIG. 9, FIG. 10, and FIG. 11 illustrate V, η, and δ as input model, mean of realizations, and high or max value of the realizations for both the empirical and random versions of the method.

Finally, referring again to FIG. 2, at operation 28 the realizations that exist within the detectability range are converted from the time domain to the depth domain. This is an optional operation that depends on the intended use of the resultant realizations.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of stochastic modeling of seismic velocity and anisotropic parameters, comprising:
a. receiving 3D bounds of normal moveout velocity (Vₙₘₒ) and anisotropic parameter η;
b. modeling 3D bounds for vertical velocity V and anisotropic parameter δ based on the 3D bounds of Vₙₘₒ and η;
c. generating 3D model realizations of V, η, and δ within the 3D bounds; and
d. testing detectability of each of the 3D model realizations to create a detectable subset of model realizations.

2. The method of claim 1 further comprising converting the detectable subset of model realizations into depth domain.

3. The method of claim 1 wherein the modeling 3D bounds for V and δ is done using random numbers generated from a predefined distribution using an empirical relationship or a random relationship between δ-η bounds.

4. The method of claim 1 wherein the generating 3D model realizations using the 3D bounds of V, η, and δ is done by sampling within the 3D bounds using random numbers generated from a predefined distribution, generating constant fluctuations with a random number generator using an empirical relation for δ-η bounds or generating constant fluctuations with a random number generator using a random relation for δ-η bounds.

5. The method of claim 1 wherein the detectability identifies which 3D model realizations will produce images with flat migrated gathers.

6. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive 3D bounds of normal moveout velocity (Vₙₘₒ) and anisotropic parameter η;
b. model 3D bounds for vertical velocity V and anisotropic parameter δ based on the 3D bounds of Vₙₘₒ and η;
c. generate 3D model realizations of V, η, and δ within the 3D bounds; and
d. test detectability of each of the 3D model realizations to create a detectable subset of model realizations.

7. The system of claim 6 further comprising converting the detectable subset of model realizations into depth domain.

8. The system of claim 6 wherein the modeling 3D bounds for V and δ is done using random numbers generated from a predefined distribution using an empirical relationship or a random relationship between δ-η bounds.

9. The method of claim 6 wherein the generating 3D model realizations using the 3D bounds of V, η, and δ is done by sampling within the 3D bounds using random numbers generated from a predefined distribution, generating constant fluctuations with a random number generator using an empirical relation for δ-η bounds or generating constant fluctuations with a random number generator using a random relation for δ-η bounds.

10. The method of claim 6 wherein the detectability identifies which 3D model realizations will produce images with flat migrated gathers.

11. A non-transitory computer readable storage medium storing one or more programs, the one or more programs comprising instructions, which when executed by an electronic device with one or more processors and memory, cause the device to
a. receive 3D bounds of normal moveout velocity (Vₙₘₒ) and anisotropic parameter η;
b. model 3D bounds for vertical velocity V and anisotropic parameter δ based on the 3D bounds of Vₙₘₒ and η;
c. generate 3D model realizations of V, η, and δ within the 3D bounds; and
d. test detectability of each of the 3D model realizations to create a detectable subset of model realizations.

12. The device of claim 11 further comprising converting the detectable subset of model realizations into depth domain.

13. The device of claim 11 wherein the modeling 3D bounds for V and δ is done using random numbers generated from a predefined distribution using an empirical relationship or a random relationship between δ-η bounds.

14. The device of claim 11 wherein the generating 3D model realizations using the 3D bounds of V, η, and δ is done by sampling within the 3D bounds using random numbers generated from a predefined distribution, generating constant fluctuations with a random number generator using an empirical relation for δ-η bounds or generating constant fluctuations with a random number generator using a random relation for δ-η bounds.

15. The device of claim 11 wherein the detectability identifies which 3D model realizations will produce images with flat migrated gathers.
